(19) United States
(12) Patent Application Publication
(10) Pub. No.: US 2008/0230529 A1
(43) Pub. Date: Sep. 25, 2008

(54) Wear-resistant welding contact tip

(76) Inventor: Ronald James Rich, Mentor, OH (US)

Correspondence Address: Ronald J. Rich, 6463 Meadowbrook Dr., Mentor, OH, 44060, US

(21) Appl. No.: 11/593,441

(22) Filed: Nov. 6, 2006

Related U.S. Application Data
(60) Provisional application No. 60/733,707, filed on Nov. 4, 2005.

(51) Int. Cl. B23K 9/28

(52) U.S. Cl. 219/137.61

(57) ABSTRACT

The present invention discloses novel metal compositions predominantly composed of copper, nickel or nickel-cobalt, and tin for use in Mig welding and other application methods to form electrically conductive, oxidation resistant, and wear resistant welding contact surfaces.

### RELATED U.S. APPLICATION DATA

This invention derives from Provisional Patent Application 60/733,707 dated Nov. 4, 2005 filed with the U.S. Patent and Trademark Office.

### ABSTRACT

The present invention discloses novel metal compositions predominantly composed of copper, nickel or nickel-cobalt, and tin for use in Mig welding and other application methods to form electrically conductive, oxidation resistant, and wear resistant weld joints and surfaces.

### BRIEF DESCRIPTION OF DRAWINGS

FIG. 1 is a general representation of a mig welding fixture used to advance a mig welding tip towards a work piece or surface.

FIG. 2 is a general schematic diagram of the mig welding system.

FIG. 3 is a magnification cross section of FIG. 1 that displays the internal structure of the mig welding fixture and mig welding contact tip being advanced through the mig welding tip fixture.

FIG. 4 is a cross sectional view of a resistance welding system that employs the contact tip of the invention.

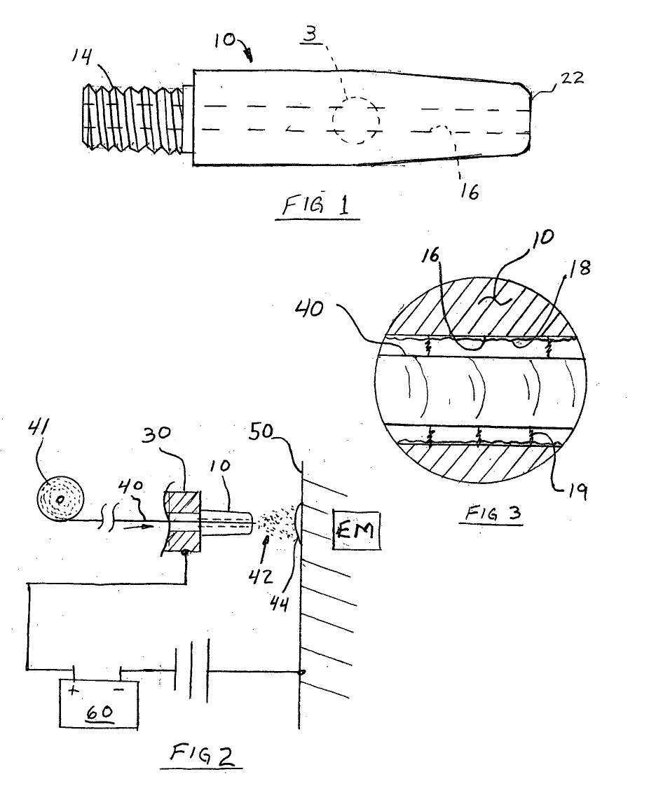

### BACKGROUND TO THE INVENTION

The invention provides for novel metal compositions based on particular alloys predominantly composed of copper, nickel or nickel-cobalt and tin for use in Mig welding and other applications that transform, transfer and deposit such novel metal compositions. A principal object of the invention is to disclose such compositions and suitable means to apply such compositions that will provide an oxidation resistant, electrically conductive contact surface and/or connection for weld joints and other electrical and/or electromechanical devices. A further object of the invention is to disclose a use of the novel composition to fabricate and use a wear resistant Mig welding tip to apply such novel compositions. Without limitation, the invention teaches a novel and useful art that employs the novel composition to; a) improve electrical conduction and device longevity in remotely situated devices; b) improve devices requiring mechanical motion across an electrically conductive surface which also completes an electrical circuit; c) improve operation of electrical, micro-mechanical devices; d) reduce the wear and erosion of Mig weld contact tips, or; e) improve resistance to corrosive degradation that otherwise results in oxidative deterioration of electrical connection materials requiring mechanical motion across an electrically conductive surface. A preferred embodiment of the invention is its use in the operation of a Mig welding process. However, one skilled in the art will understand how the improvements disclosed herein can apply to alternate welding and plasma applications for applying such novel compositions to various work piece connections and surfaces.

In the prior art, Mig welding is a conventional arc welding process. Referring to FIG. 2, an exemplary such process is shown for convenience and completeness of description. Briefly, a rod of welding material 40 is advanced toward a workpiece 50 and heated beyond its vaporization temperature in proximity to the workpiece to generate liquid droplets or a metallic plasma 42. This liquid or plasma 42 then is attracted toward the workpiece 50 via an electromagnetic force (EM), until it settles onto the workpiece and re-condenses and solidifies to provide a solid weld-seam or weld-joint 44.

The rod 40 can be fed from a roll 41 and is advanced through a welding tip 10 that is positioned in proximity with the portion of the workpiece it is desired to weld as shown in FIG. 2. The welding tip is mounted to a base 30 that is electrically coupled to the workpiece 50 via a voltage source 60. The proximity between the distal end 22 of the welding tip 10 and the surface of the workpiece 50 is selected or adjusted to provide an optimal distance to produce an electrical arc based on the voltage applied between the base 30 to which the welding tip 10 is electrically coupled (typically screwed in via threads 14) and the workpiece 50, which arc vaporizes the metal at the end of the rod 40 thus producing the plasma 42.

### Preferred Embodiment of the Invention

In the prior art, the most common material used for the welding tip 10 is pure copper. Pure copper has been preferred because of its high electrical and thermal conductivity, given the importance of these attributes to 1) heating the rod of welding material 40, and 2) sustaining an electrical arc to generate the plasma 42. However, during the process of Mig welding, copper welding tips tend to wear and erode rather quickly. As the axial bore 16 of a copper welding tip becomes eroded or fouled, further advancement of the rod 40 becomes more difficult or in extreme cases impossible. It is believed this fouling is a result of mechanical wearing or erosion of the inner wall of the bore 16 from very severe conditions during operation; i.e. sustained temperatures of 600-1000° F. and an electrical current of 100-500 amps for most applications.

It has been discovered that when the welding tip 10 is made from an alloy as described in Table 1 below, it exhibits a significantly greater degree of wear resistance compared to copper, and performs comparably to copper in terms of transferring adequate heat to the rod 40 as well as sustaining an arc with the workpiece 40.

In Table 1, any concentration or range of any of the alloy components can be combined with any other concentration or range of any of the other alloy components; it is not necessary that all concentrations or concentration ranges for all alloy components come from the same column in Table 1 to produce an alloy as contemplated herein.

TABLE 1
Alloy composition for Mig welding tip

| | Preferred Conc. | Less Preferred | Less Preferred |
|---|---|---|---|
| Element | (wt. %) | Conc. (wt. %) | Conc. (wt. %) |
| Nickel | 8.5-9.5 | 7-15 | 4-25 |
| | | | 5-22 |
| Tin | 5.5-6.5 | 4-8 | 2-15 |
| | | | 3-10 |
| Zinc | 0-0.5 | 0-0.5 | 0-0.5 |
| Iron | 0-0.5 | 0-0.5 | 0-0.5 |
| Copper | Balance | Balance | Balance |

Alternatively to nickel in table 1, the alloy may include a nickel-cobalt, in which case the nickel-cobalt concentration preferably is in the range of 14.5-15.5 weight percent, less preferably 13-17, less preferably 10-20 or 5-22, weight percent.

The alloy of Table 1 also may contain trace or minor quantities of other metals such as magnesium, manganese, niobium and other trace metals in quantities less than 0.5 percent by weight, more typically less than 0.3 percent by weight. Lead also may be present as a trace impurity, but preferably is present in a concentration of less than 0.1, more preferably 0.05, more preferably 0.03, percent by weight.

Suitable alloys as in Table 1 are available commercially from Brush Wellman Inc. of Cleveland, Ohio, under the tradenames moldMAX XL® and ToughMet®.

Unlike pure copper, an alloy as in Table 1 is hardenable and can be hardened, e.g., via heat treatment or temper, or otherwise via a wrought method such as cold working. It may be desirable to form the welding tip 10 from the soft alloy first, and then to harden it. In this case, the welding tip 10 may be desired to be hardened via a heat treatment method, as wrought or working techniques would tend to destroy the shape of the welding tip. Alternatively, the welding tip 10 can be machined, e.g., from a pre-heat-treated or hardened dowel of the alloy, which has been successful.

A welding tip 10 made with the alloy of Table 1, because of its significant hardness, is much more wear and erosion resistant than pure copper and thus can endure many more hours of service contributing to less down time for the Mig welder.

The alloy of Table 1 has lower electrical conductivity than pure copper, which ordinarily would lead one skilled in the art to believe it is not suitable for Mig welding tips which must be very electrically conductive to sustain the above-noted electrical arc. However, surprisingly and unexpectedly it has been found that a welding tip 10 made from such alloy performs comparably and in some cases has even been shown to perform better than a pure copper welding tip under identical test conditions.

Without wishing to be bound by a particular theory, it is believed this comparable/better performance of the alloy in Table 1, despite being less electrically conductive than pure copper, is because of one or more of the following reasons.

It is well known that metal surfaces become coated with oxide layers, wherein surface-bound metal atoms become oxidized by atmospheric oxygen. Such oxide layers are produced to differing degrees based on the surface metal's own stability or oxidation potential, the concentration of ambient oxygen, service temperature and, importantly for the present application, circumstances of electrical conduction or arcing.

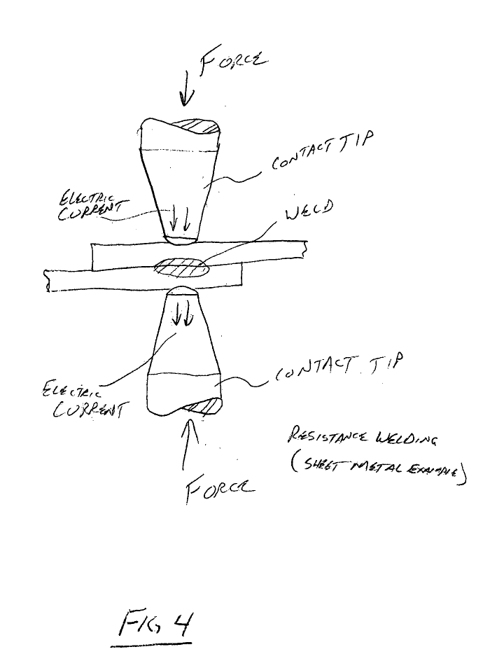

Ordinarily, one would expect there to be a surface oxide layer 18 on the inner surface of the axial bore 16 of the welding tip 10; in the case of pure copper, copper is well known to oxidize (visibly, to “tarnish”) when exposed to atmospheric oxygen. The degree of oxidation or “tarnishment” depends on the length of the exposure. In addition, the oxidation process can be greatly increased if the copper surface is heated significantly, or subjected to an electrical arc, both of which tend to excite the surface atoms making them more reactive and thus more apt to pick up atmospheric oxygen molecules to generate surface-bound oxides. Both of these mechanisms occur within the axial bore 16. For example, as shown in FIG. 3 the welding material rod 40 has a smaller diameter than the bore 16. Sometimes the rod 40 will contact the inner wall surface of the bore 16 and sometimes it will not. When it does, direct metal-to-metal conduction occurs to complete the electrical circuit through the rod 40 and the plasma 42 between the tip 10 and the workpiece 50. When the rod 40 and the welding tip 10 are not in contact, it is believed that current is transferred via “mini-arcs” 19 to complete the circuit. Whether through direct conduction or the generation of these “mini-arcs” 19, current must pass through the oxide layer 18, which itself is non-conductive, to reach the rod 40.

It is believed that the alloy of Table 1 either resists the formation of an oxide layer altogether under Mig welding conditions, or otherwise the oxide layer is of a lower thickness, lower density, or in some other way it presents less of an impediment to the passage of current therethrough. For this reason, it is believed, although the alloy itself is less electrically conductive than pure copper, the alloy of table 1 presents a comparable or in some cases a better total current carrying capacity than pure copper, at least under Mig welding conditions, due to the absence or difference in character (i.e. lower resistivity) of the corresponding oxide layer. This was a highly surprising and unexpected result.

A welding tip 10 made with the alloy of Table 1 possesses hardness and high strength, good corrosion resistance, high thermal conductivity for total current capacity comparable to or better than pure copper, as well as lubricity and wear resistance. Specifically, in addition to reduced wear rate compared to pure copper, the welding tip 10 made from this alloy also exhibits greater lubricity, perhaps as a result of reduced fouling of the axial bore 16 due to erosion under severe thermal and electrical conditions. In addition, the alloy disclosed herein has a higher melting temperature than pure copper.

Alternatively the material described above can be used for resistance welding contact tips. A resistance welding process is illustrated schematically in FIG. 4. The reduced wear rate compared to traditional materials would improve the life of the contact tip. This reduced wear would give a more consistent weld for this application because the wear on the contact tip changes the geometry of the tip, which would in turn reduces the contact pressure profile which is a main variable for resistance welding performance.

It is believed that the alloy of Table 1 would maintain the total current carrying capacity for resistance welding contacts similarly as for a Mig welding contact tip; although “mini-arcs” may or may not be present in the resistance weld process.

### Prior Art Review

Mig welding devices have been the subject matter of prior inventions including the following U.S. patents; U.S. Pat. No. 5,841,105 [Automatic mig welding torch and method of assembly], U.S. Pat. No. 5,086,208 Hand held electric arc welder], and U.S. Pat. No. 4,931,018 [Device for training welders]. None of these prior disclosures disclose the use of welding tip compositions described in the present invention.

As mentioned previously, suitable alloys as in Table 1 are available commercially from Brush Wellman Inc. of Cleveland, Ohio, under the tradenames moldMAX XL® and ToughMet®. These materials were specifically developed as mold and die materials. A review of the Brush Wellman literature does not indicate any prior use of or disclosure of the present invention which is concerned with welding and electrically conductive uses of such alloys.

What is claimed is:

1. A welding tip made with an alloy as described in Table 1.

2. A welding tip made with a substantially Cu—Sn—Ni alloy, wherein Sn is present in a concentration of 3-10 wt. %, Ni is present in a concentration of 5-22 wt. %, balance being substantially Cu and trace impurities of less than about 0.5 wt. % each.

3. A welding tip of claim 2, Cu being present in a concentration of 83-85 wt %.

4. A welding tip of claim 3, Ni being present in a concentration of 8.5-9.5 wt. % and Sn being present in a concentration of 5.5-6.5 wt. %.

5. A welding tip of claim 4, a where a Ni—Co mixture substitutes for Ni, being present in a concentration of 5-22 wt. %.

6. A welding tip of comprised of any composition set forth in claims 1-4, said welding tip being a Mig welding tip.

7. A welding tip of comprised of any composition set forth in claims 1-4, said welding tip being a resistance welding tip.

8. A welding tip of claim 6 or claim 7 where said tip is composed of such composition that has been cold formed to increase its hardness.

9. A welding tip of claim 6 or claim 7 where said tip is composed of such composition that has been heat treated to increase its hardness.

10. A welding tip of claim 8 where said tip is composed of such composition that has been cold formed heat treated to further increase its hardness.
